(19) United States
(12) Patent Application Publication
(10) Pub. No.: US 2014/0205385 A1
(43) Pub. Date: Jul. 24, 2014

(54) PUMP FRAME

(71) Applicants: Wilhelmus Jacobus Bekker, Zwijndrecht (NL); Marco Njord Oele, Rotterdam (NL); Rick Lotman, Gorinchem (NL)

(72) Inventors: Wilhelmus Jacobus Bekker, Zwijndrecht (NL); Marco Njord Oele, Rotterdam (NL); Rick Lotman, Gorinchem (NL)

(73) Assignee: IHC HOLLAND IE B.V., Sliedrecht (NL)

(21) Appl. No.: 14/234,180

(22) PCT Filed: Jul. 18, 2012
(86) PCT No.: PCT/NL2012/050516

§ 371 Date: Mar. 27, 2014

(30) Foreign Application Priority Data
Jul. 21, 2011 (NL) 2007158

(51) Int. Cl. B65G 53/42

(52) U.S. Cl. CPC B65G 53/42
USPC 406/113

(57) ABSTRACT

A riser system for transporting slurry from a sea bed (4) includes a vertical riser pipe (10) and at least one pump (30) provided along the riser pipe (10). The riser pipe (10) includes a pipe input opening (12). The riser system includes a frame (40) to which the pump (30) is mounted. The frame (40) has a first connection member (41) at a predetermined distance from a pump output opening (32). The riser system includes a second connection member (15) provided along the riser pipe (10) at the predetermined distance above the pipe input opening (12). The first and second connection member (41, 15) are rotatably connectable allowing the frame (40) to rotate under the influence of gravity to a hanging position in which the pump output opening (32) connects to the pipe input opening (12).

### TECHNICAL FIELD

The invention relates to a riser system for transporting slurry from a sea bed towards the surface of a water body. The invention further relates to a frame for such a riser system, a riser pipe for such a riser system, and a method for connecting such a frame to such a riser pipe.

### STATE OF THE ART

Risers are commonly used in the field of sub-sea and deep-water mining and dredging. Mining and dredging may be done at depths up to several kilometres. A riser is a vertical transport system for transporting material, slurry, gathered at the sea bed, e.g. by SMT's (subsea mining tool), in an upward direction towards the water surface, for instance to a mining vessel. The riser system may also be used to transport material, such as waste water, in a downward direction.

The riser system may be formed as a tube that is at its upper end (riser top) connected to the vessel, for instance by a flexible hose or an articulated joint. The lower end (riser base) is positioned at or just above the sea bed and is arranged to receive material, such as mined materials, to be transported to the vessel via the riser system. The lower end of the riser system may for instance be connected to a mining tool via a jumper or flexible hose, giving the mining tool the necessary freedom of movement. In order to transport the slurry in the upward direction a pump may be provided at the lower end of the riser system. The limited power of the pump limits the distance that can be bridged by the vertical transport system. Typically, a pump can cover 200-300 metres in upward direction.

The riser system may also be formed by a plurality of parallel riser pipes, for instance four riser pipes, two of which may be used for upward transport and two of which may be used for downward transport.

However, mining materials are also found at greater depths, for instance at depths of 2000 metres.

In order to bridge such a distance, riser systems are known which further comprise one or more pumps at different depths along the riser system.

U.S. Pat. No. 4,718,835 (Maruyama) describes a deep see mining apparatus comprising a lift pipe (riser pipe). A plurality of jet pumps are connected in the pipe at intermittent locations along the length of the pipe, and a hydraulic feed pump is located adjacent each of the jet pumps which discharge water in order to supply the jet pumps. The main body of the jet pumps are coupled to a section of the riser pipe by flanges, forming a central linear passage that is coaxial with the riser pipe.

One disadvantage of this system is the fact that the pumps are located in line with the riser pipe, leading to a complete shutdown of the riser pipe when a pump needs to be replaced. In order to replace a pump, the defect pump has to be taken out of the riser pipe and be replaced by a new working pump. This causes severe time delays in the mining process.

It is an object of the invention to provide a riser system that allows for easy and time-efficient replacement of a pump.

### SHORT DESCRIPTION

According to an aspect there is provided a riser system for transporting slurry from a sea bed towards the surface of a water body, the riser system comprising a substantially vertical riser pipe and at least one pump provided along the riser pipe for transporting the slurry in an upward direction, wherein the riser pipe comprises a pipe input opening, the riser system comprises a frame to which the pump is mounted, the pump comprising a pump input opening and a pump output opening, the frame comprising a first connection member at a predetermined distance from the pump output opening, the riser system comprising a second connection member provided along the riser pipe at the predetermined distance above the pipe input opening, the first and second connection member being rotatably connectable allowing the frame to rotate under the influence of gravity to a hanging position in which the pump output opening connects to the pipe input opening.

The advantage of such a riser system is that the pumps can easily be mounted and dismounted in case of need of replacement of a pump, without having to open up the riser pipe and shutting down the mining operation.

In addition, such a riser system allows for easy mounting of booster stations below the water surface. By simply connecting the frame to the riser pipe, gravity pulls the frame towards a correct orientation. Once the frame is connected to the riser system, the frame is pulled to a hanging position in which the pump is automatically aligned with the pipe input opening allowing easy connection.

In the hanging position the pump output opening and the pipe input opening face each other in a horizontal direction.

Furthermore, the riser systems makes it relatively easy to remove the frame and the pump, as will be explained in more detail below. This allows for an easy, quick and reliable change of booster stations, thereby making maintenance relatively easy. Downtime of the riser is reduced.

According to an embodiment the pipe input opening is an intermediate pipe input opening positioned at an intermediate position along the pipe and the riser system further comprises an intermediate pipe output opening adjacent the intermediate pipe input opening, and wherein in the hanging position the pump output opening connects to the intermediate pipe input opening and the pump input opening connects to the intermediate pipe output opening.

According to this embodiment, frames can be mounted at predetermined positions along the riser pipe to transport material over a vertical distance that is larger than can be covered by a single pump.

The pipe may be closed in between the intermediate pipe input and output openings, such that all material to be transported is forced to leave the pipe via the intermediate pipe input and can return into the pipe via the intermediate pipe input opening.

According to an embodiment the first connection member is a hook, and the second connection member is hook receiving member.

Such an embodiment ensures that the frame can be connected to the riser system by lowering the frame and ensures that the frame remains in position under the influence of gravity when in the hanging position. Removal of the frame can be done by lifting the frame.

According to an embodiment the frame comprises a hoist connection member to which a hoisting cable can be attached to lower and lift the frame along the riser pipe, the frame being in a hoisting orientation. The hoisting connection member can be a ring shaped member to which a hoisting hook can be attached.

The hoisting orientation is different from a hanging orientation, i.e. the orientation of the frame when it is in the hanging position. In the hoisting position, the frame is orientated such that the first connection member is orientated diagonally above the pump output opening.

In the hanging position, the first connection member is substantially positioned above the pump output opening.

According to an embodiment the frame comprises a winch with a rope, the winch being position near the first connection member and the riser pipe comprises a rope connection member along the riser pipe near the second connection member, wherein the rope can be connected to the rope connection member and the position of the frame can be adjusted relative to the riser pipe by pulling in the rope by the winch. This allows an easy way to position the frame with respect to the riser pipe.

According to an embodiment one of the pump output opening and the pipe input opening comprise a widening end part to catch the other of the pump output opening and the pipe input opening when the frame reaches the hanging position and/or one of the pump input opening and the intermediate pipe output opening comprise a widening end part to catch the other of the pump input opening and the intermediate pipe output opening when the frame reaches the hanging position.

This widening end part, which may also be described as a funnel part, ensures that when the frame rotates to its hanging position, the pump output opening and the pipe input opening are aligned such that a reliable connection is ensured. When the frame approaches the hanging position, the alignment of the two members to be connected may not be perfect, for instance due to water currents. The widening end part catches the other part and thereby ensures that the two parts are aligned when the hanging position is reached.

According to an embodiment the riser system comprises a plurality of intermediate pipe input openings positioned at different intermediate positions along the pipe and intermediate pipe output openings adjacent the respective intermediate pipe input openings, and wherein the riser system comprises a number of second connection members at the predetermined distance above the respective intermediate pipe input openings.

By providing a plurality of intermediate pipe input and output openings along the pipe and corresponding second connection members, a plurality of frame with pumps can be positioned along the riser system to transport material in upward direction over a larger distance than can be covered by a single pump.

For instance, by providing 10 pumps along the pipe, where each pump has a vertical transport capacity of 300 metres in upward direction, a total distance of approximately 3000 metres can be covered.

According to an embodiment the frame further comprises a winch with a rope positioned near the first connection member, the riser system further comprises a rope connection member provided along the pipe above the pipe input opening, wherein the winch is arranged to give out rope when the frame approaches the location along the riser pipe to which the frame is to be mounted, wherein the rope is connectable to the rope connection member, wherein the winch comprises an actuator arranged to pull in the rope to bring the first connection member towards the second connection member.

The winch and the rope can be used to transport the frame towards the riser pipe during installation of the frame to the riser pipe. The winch may be controlled by a remotely operated underwater vehicle (ROV) and may be positioned on the frame close to the first connection member. The rope connection member provided along the riser pipe may be positioned close to the second connection member. The ROV may take the rope, connect it to the rope connection member provided along the pipe and control the winch to pull in the rope.

According to an embodiment the frame comprises a first power connection member, wherein a second power connection member is provided along the riser pipe, the first and second power connection members having the same relative position with respect to the first and second connection member, such that in the hanging position the first and second power connection member connect to each other.

The second power connection member may be connected to a power source via an umbilical that is provided along and attached to the riser pipe. The first and second power connection members may be of a plug-and-socket type.

The first and second power connection member may be provided to provide the equipment on the frame with the necessary power.

According to an embodiment the frame comprises a first control connection member, wherein a second control connection member is provided along the riser pipe, the first and second control connection members having the same relative position with respect to the first and second connection member, such that in the hanging position the first and second control connection member connect to each other.

According to an embodiment the riser system comprises a locking device arranged to lock the pump output opening to the pipe input opening and or comprises a locking device arranged to lock the pump input opening to the pipe output opening. This ensures that the pump is fixedly connected to the riser pipe and can withstand water currents and waves and the like.

According to an embodiment at least one of the pump input opening and the intermediate pipe output opening comprises a sealing member for sealing the connection between the pump input opening and the pipe output opening and/or wherein at least one of the pump output opening and the intermediate pipe input opening comprises a sealing member for sealing the connection between the pump output opening and the pipe input opening. This provides a water tight connection between the pump and the riser pipe.

According to an aspect there is provided a frame for a riser system, wherein the frame carries a pump with a pump input opening and a pump output opening, wherein the frame comprises a connection member at a predetermined distance from the pump output opening, which connection member is arranged to be rotatably mounted to a riser pipe, allowing the frame to perform a rotation after connection under the influence of gravity to a hanging position, wherein an axis of the pump output opening is substantially tangentially directed with respect to the rotation of the frame.

According to an embodiment the frame comprises a hoist connection member to which a hoisting cable can be attached to lower and lift the frame along a riser pipe, the frame being in a hoisting orientation.

According to an embodiment at least one of the pump output opening and the pump input opening is provided with a sealing member.

According to an embodiment at least one of the pump output opening and pump input opening is provided with a locking device.

According to an embodiment the frame further comprises a winch with a rope positioned close to the first connection member, wherein the winch is arranged to give out rope during when the frame approaches the location along the riser pipe to which the frame is to be mounted, wherein the rope is connectable to a rope connection member along the pipe above the pipe input opening provided on the riser system, wherein the winch comprises an actuator which is arranged to pull in the rope to connect the connection member to the riser pipe.

According to an embodiment the frame comprises a power connection member, wherein an axis of the power connection member is substantially tangentially directed with respect to the rotation direction of the frame.

According to an embodiment the frame comprises a further control connector, wherein an axis of the power connection member is substantially tangentially directed with respect to the rotation direction of the frame.

According to an aspect there is provided a riser pipe for a riser system, wherein the riser pipe comprises a pipe input opening and a connection member at a predetermined distance above the pipe input opening, which connection member is arranged to be connected to a frame.

According to an embodiment the connection member is arranged to be rotatably mounted to a frame, allowing the frame to perform a rotation after connection under the influence of gravity to a hanging position, wherein an axis of the pipe input opening is substantially tangentially directed with respect to the rotation of the frame.

According to an embodiment the pipe input opening is an intermediate pipe input positioned at an intermediate position along the pipe and the riser pipe further comprises an intermediate pipe output opening adjacent the intermediate pipe input opening.

According to an embodiment the pipe input opening comprises a widening end part.

According to an embodiment the intermediate pipe output opening comprises a widening end part.

According to an embodiment the riser pipe comprises a plurality of intermediate pipe input openings positioned at different intermediate positions along the pipe and intermediate pipe output openings adjacent the respective intermediate pipe input openings.

According to an embodiment at least one of the pipe output opening and the pipe input opening is provided with a sealing member.

According to an embodiment a rope connection member is provided along the riser pipe above the pipe input opening.

According to an embodiment the riser comprises one or more riser pipes according to the above.

According to an embodiment the riser comprises at least two riser pipes with mirrored intermediate pipe input openings and adjacent intermediate pipe output openings relatively to each other.

According to an aspect there is provided a method for connecting a frame, comprising a pump, to a riser pipe, the frame comprising a first connection member, a hoisting connection member, a winch with a rope, the winch being positioned near the first connection member, the riser pipe comprising a second connection member and a rope connection member along the riser pipe near the second connection member, the method comprising:
hoisting the frame to a suitable height, whereby the frame is in a hoisting orientation;
connecting the rope to the rope connection member;
adjusting the position of the frame relative to the riser pipe by pulling in the rope by the winch;
connecting the first connection member of the frame to the second connection member of the riser pipe;
making the frame rotate into a hanging position under influence of gravity;
connecting an output opening of the pump to an input opening of the riser pipe.

According to an embodiment the method comprises
connecting an input opening of the pump to an output opening of the riser pipe.

According to an embodiment the pipe input opening is an intermediate pipe input opening positioned at an intermediate position along the pipe and the pipe output opening is an intermediate pipe output opening adjacent the intermediate pipe input opening.

### SHORT DESCRIPTION OF THE DRAWINGS

Embodiments will now be described, by way of example only, with reference to the accompanying schematic drawings in which corresponding reference symbols indicate corresponding parts, and in which:

FIG. 1 schematically depicts an embodiment,

FIGS. 2a and 2b schematically depict a perspective view of embodiments.

### DETAILED DESCRIPTION

In the embodiments described in detail below with reference to the figures, a frame is described that can connect to a riser pipe and has an interface that can connect to an interface provided along the riser pipe. The frame can be mounted at different water depths along the riser pipe.

The frame may comprise a pump that can be connected to the riser pipe to pump material in upward direction. The frame may further comprise additional equipment such as an electromotor to power the pump, sensors, conduits to connect the pump to the riser pipe, connectors to connect to a power supply cable, connectors to connect to a control cable.

The pump may be a centrifugal pump. However, any suitable type of pump may be used.

The frame and the equipment attached to the frame may be referred to as a booster station.

The frame may comprise a hook that can be connected to a corresponding part of the riser pipe, such as a hook receiving member. The connection between the frame and the riser pipe allows for rotational movement of the frame in a substantial vertical plane, allowing the frame to move towards the riser pipe under the influence of gravity and to allow the one or more device on the frame, such as the pump, to connect to the riser pipe.

The frame may further comprise a winch with a rope. The rope may be pulled out by a ROV, connected to the riser pipes when the frame approaches the riser system. Next, the winch may be activated to pull in the rope to bring the hook of the frame towards the hook receiving member. The winch with rope may be positioned near the first connection member.

The connection between the equipment provided on the frame and the corresponding connection members provided along the riser pipe may be self-aligning.

The embodiments will be described in more detail below with reference to the drawings.

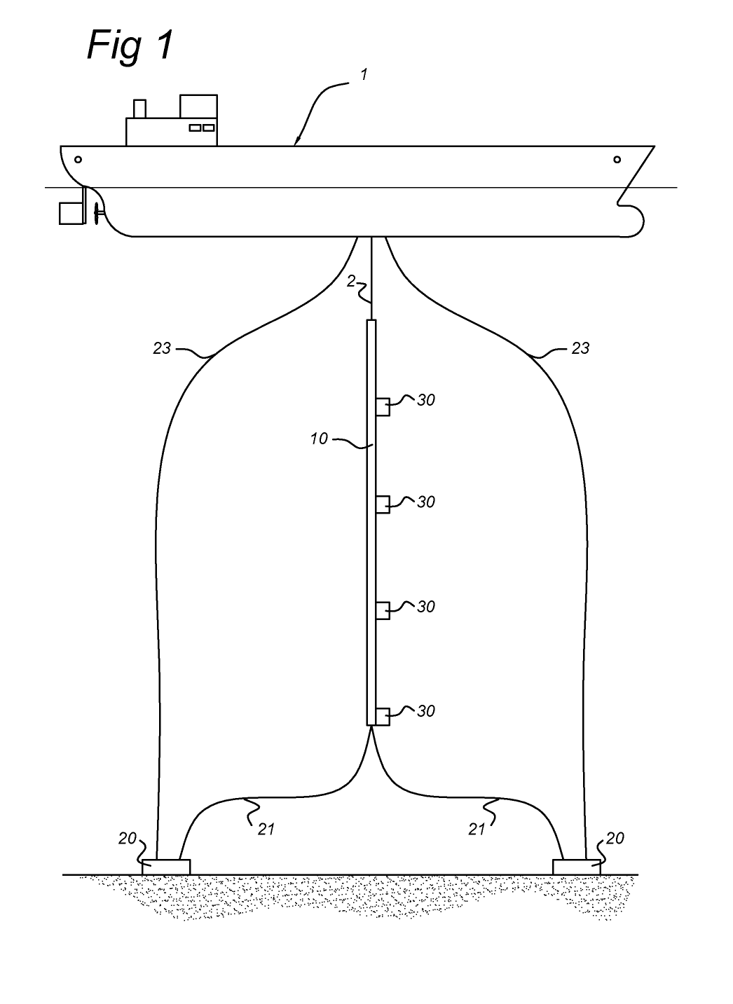

FIG. 1 shows a riser system according to an embodiment. The riser system being arranged for transporting slurry from a sea bed towards the surface of a water body.

FIG. 1 shows a mining vessel 1. A riser pipe 10 is connected to the mining vessel 1 via a flexible riser 2. The riser pipe is shown as being made out of one piece, but it will be understood that the riser pipe 10 may be assembled out of many different riser pipe elements.

The lower end of the riser pipe 10 (riser base) is positioned just above the sea bed and is arranged to receive material, such as mined materials, to be transported to the mining vessel 1 via the riser system. The lower end of the riser pipe 10 is connected to two subsea mining tools 20 via jumpers or flexible hoses 21. The subsea mining tools 20 may be connected to the mining vessel 1 by means of umbilicals 23. In order to transport the slurry in the upward direction a pump 30 may be provided at the lower end of the riser system 30 and at a number of positions along the riser pipe 10. In the example shown, four pumps 30 are provided. The riser system may therefore comprise a plurality of intermediate pipe input openings positioned at different intermediate positions along the pipe and intermediate pipe output openings adjacent the respective intermediate pipe input openings to which the pumps 30 may be connected.

According to a variant, instead of one riser pipe 10, four parallel riser pipes 10 are provided arranged in a square pattern. Two riser pipes 10 may be used for transporting material in upward direction and are therefore equipped with pumps 30 at a plurality of positions along the riser pipes 10. Two other riser pipes 10 may be used for transporting material in downward direction and are therefore not provided with pumps 30.

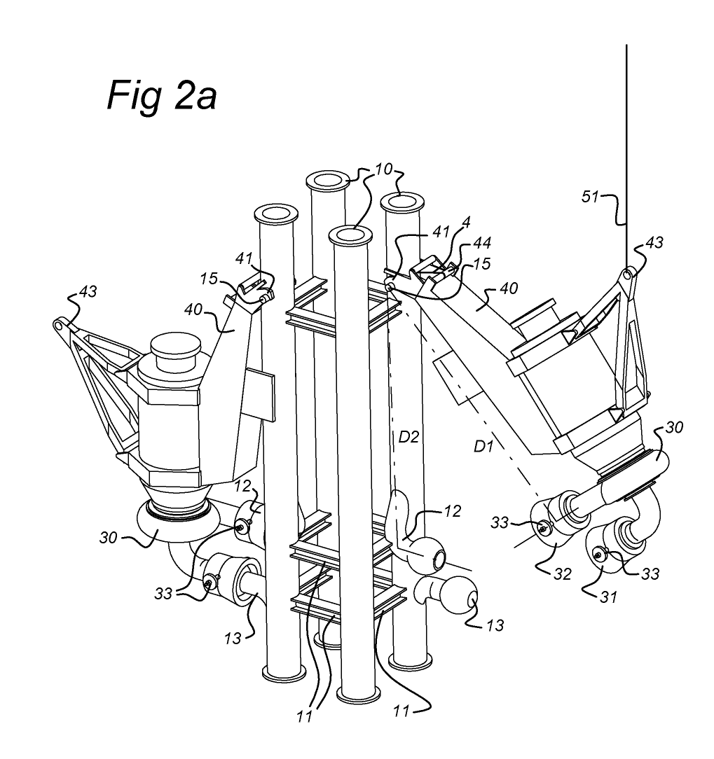

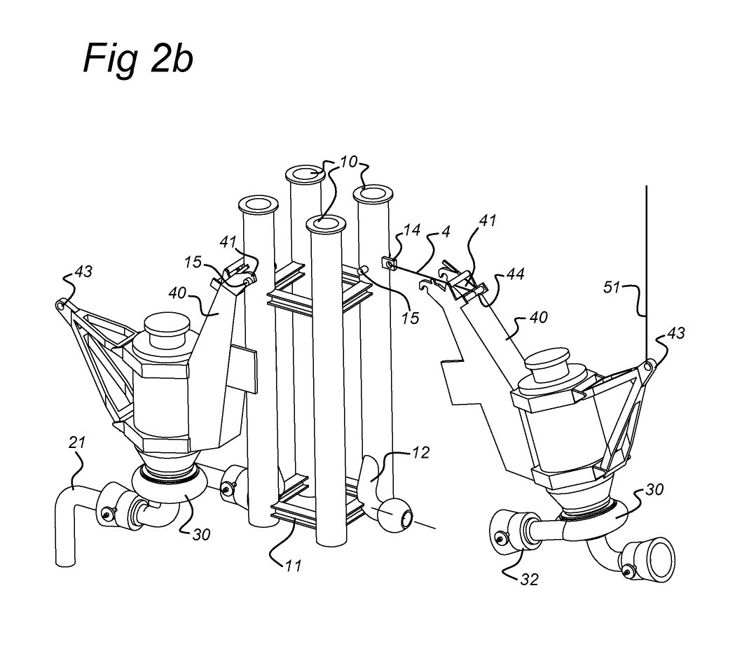

FIGS. 2a and 2b show a detailed view of a riser system comprising four parallel riser pipes 10 also showing two pumps 30. The riser pipes 10 are connected by connecting members 11, which keep the riser pipes 10 in the square pattern. FIG. 2a shows an intermediate position of the riser pipes 10, where FIG. 2b shows the lower end of the riser pipe 10 (riser base). In FIG. 2b the right frame 40 is not yet connected to the riser pipe 10.

FIGS. 2a and 2b further shows that at least the two riser pipes 10 used for upward transport comprise a pipe input opening 12. The riser system comprises a frame 40 to which the pump 30 is mounted, the pump 30 comprises a pump input opening 31 and a pump output opening 32. The frame 40 comprises a first connection member 41 at a predetermine distance D from the pump output opening 32.

The riser system comprises a second connection member 15 provided along the riser pipe 10 at the predetermined distance D above the pipe input opening 12.

The first and second connection members 41, 15 being rotatably connectable allowing the frame 40 to rotate under the influence of gravity to a hanging position in which the pump output opening 32 connects to the pipe input opening 12. In FIGS. 2a and 2b the left hand-side frames 40 are shown in the hanging position, while the right hand-side frames 40 are shown in a hoisting orientation.

The first connection member 41 may be a hook and the second connection member 15 may be a hook receiving member. As shown in FIGS. 2a and 2b, the first connection member 41 may be a double hook that engages second connection members 15 provided on both sides of the respective riser pipe 10. Of course, other suitable types of connection members 41, 15 may be used instead.

FIG. 2a shows an intermediate location along the riser pipes 10. FIG. 2a schematically depicts the pipe input opening 12 as being an intermediate pipe input opening 12 positioned at an intermediate position along the riser pipe 10. The riser system further comprises an intermediate pipe output opening 13 adjacent the intermediate pipe input opening 12. In the hanging position the pump output opening 32 connects to the intermediate pipe input opening 12 and the pump input opening 31 connects to the intermediate pipe output opening 13.

In order to lock the connection between the pump output opening 31 and the pipe input opening 12 and the pump input opening 32 and the pipe output opening 13 a locking device 33, such as screw down locks, is provided. The locking device 33 can be operated by the ROV.

In order to prevent leakage through the connection of the input and output openings, sealing members, such as rubber sleeves, are provided for sealing the connection between the pump output opening and the pipe input opening.

FIG. 2b shows the lower end of the riser pipe 10 (riser base), end the lowest pump of the riser system. FIG. 2b therefore doesn't show a pipe output opening 13, but instead shows a jumper or flexible hose 21 that may be provided to connect the subsea mining tools 20 to the riser pipe 10.

FIGS. 2a and 2b further show that the frame comprises a hoist connection member 43 to which a hoisting cable 51 can be attached to lower and lift the frame 40 along the riser pipe 10. The hoisting cable 51 may be connected to and operated from the mining vessel 1.

The hoist connection member 43 is positioned such that the frame is in a hoisting orientation when being hoisted. The hoisting orientation being different from the orientation associated with the hanging position. As will be understood from FIGS. 2a and 2b, in the hanging position, the pump output opening 32 is directed substantially vertically below the first connection member 41 of the frame 40, while in the hoisting orientation, the pump output opening is positioned diagonally or horizontally with respect to the first connection member 41.

As is best shown in FIG. 2b, the frame 40 may comprise a winch 44 with a rope 4. When the frame approaches the intended position along the riser pipe, the winch 44 may give out rope 4. The rope 4 may then be connected to a rope connection member 14 attached to the riser pipe 10. This may be done with the aid of a ROV. The winch 44 may then pull in the rope 4 to move the frame 40 to the intended position along the riser pipe 10 to allow the first and second connection members relative to each other and allow them to connect.

Once the frame 40 is connected to the riser pipe 10 by means of the first and second connection member 15, 41, the hoisting cable can be removed or lowered to allow gravity to pull the frame 40 towards its hanging position. Under the influence of gravity, the frame 40 performs a rotation in a substantially vertical plane, i.e. about a vertical rotational axis. In the embodiments depicted, the vertical rotational axis is perpendicular to the body axis of the riser pipe 10 and substantially perpendicular to the direction of the (intermediate) pipe input opening 12.

FIGS. 2a and 2b further show that the pump output opening 32 comprises a widening end part. Such a widening end part may be provided to allow an easy and fail-safe connection, even when the alignment of the parts to be connected is not perfect. The widening end part of the pump output opening 32 is provided to catch the (intermediate) pipe input opening 12 when the frame rotates towards its hanging position.

As shown in FIGS. 2a and 2b, the pump input opening 31 may also be provided with a widening end part.

It will be understood that the same effect may be obtained by providing the (intermediate) pipe input opening 12 and/or the pipe output opening 13 with widening parts.

The embodiments described above with reference to the figures can be used by employing a method for connecting the frame 40, comprising the pump 30 to the riser pipe 10.

The method comprises:
Hoisting the frame 40 to a suitable height, whereby the frame 40 is in a hoisting orientation. Hoisting may be done from a vessel using a suitable hoisting crane or the like.
Connecting the rope 4 to the rope connection member 14. This may be done with the aid of a ROV. The connection member may for instance be a ring.
Adjusting the position of the frame 40 relative to the riser pipe 10 by pulling in the rope 4 by the winch 44.
Connecting the first connection member 41 of the frame 40 to the second connection member 15 of the riser pipe 10. By pulling in rope 4 the frame 40 the first and second connection member 41, 15 have a relative position which allows easy connection. When the rope 4 is fully pulled in, the first and second connection member 41, 15 may already be in contact with each other.
Making the frame 40 rotate into a hanging position under influence of gravity. This may simply be done by lowering the frame 40 by giving out more hoisting cable 51.
Connecting an output opening 32 of the pump 30 to an input opening 12 of the riser pipe 10 and possibly
connecting an input opening 31 of the pump 30 to an output opening 13 of the riser pipe 10. The output opening 32 and the input opening 12 are automatically aligned with respect to each other when the frame is in the hanging position.

According to an embodiment the pipe input opening 12 is an intermediate pipe input opening 12 positioned at an intermediate position along the pipe 10 and the pipe output opening is an intermediate pipe output opening 13 adjacent the intermediate pipe input opening 12.

The descriptions above are intended to be illustrative, not limiting. Thus, it will be apparent to one skilled in the art that modifications may be made to the invention as described without departing from the scope of the claims set out below.

### LIST OF PARTS

1. Mining vessel
2. Flexible riser
4. Rope
10. Riser pipe
11. Connecting member
12. Pipe input opening
13. Pipe output opening
14. Rope connection member
15. Second connection member
20. Subsea mining tool
21. Flexible hoses or jumpers
23. Umbilicals
30. Pump
31. Pump input opening
32. Pump output opening
33. Locking device
40. Frame
41. First connection member
43. Hoist connection member
44. Winch
51. Hoisting cable

1-35. (canceled)

36. A riser system for transporting slurry from a sea bed (4) towards the surface of a water body, the riser system comprising
a substantially vertical riser pipe (10) and at least one pump (30) provided along the riser pipe (10) for transporting the slurry in an upward direction,
the riser pipe (10) comprising a pipe input opening (12),
the riser system comprising a frame (40) to which the pump (30) is mounted, the pump (30) comprising a pump input opening (31) and a pump output opening (32),
the frame (40) comprising a first connection member (41) at a predetermined distance from the pump output opening (32),
the riser system comprising a second connection member (15) provided along the riser pipe (10) at the predetermined distance above the pipe input opening (12),
the first and second connection member (41, 15) being rotatably connectable allowing the frame (40) to rotate under the influence of gravity to a hanging position in which the pump output opening (32) connects to the pipe input opening (12).

37. The riser system according to claim 36, wherein the pipe input opening (12) is an intermediate pipe input opening (12) positioned at an intermediate position along the pipe (10) and the riser system further comprises an intermediate pipe output opening (13) adjacent the intermediate pipe input opening (12), and wherein in the hanging position the pump output opening (32) connects to the intermediate pipe input opening (12) and the pump input opening (31) connects to the intermediate pipe output opening (13).

38. The riser system according to claim 36, wherein the frame (40) comprises a hoist connection member (43) to which a hoisting cable (51) can be attached to lower and lift the frame (40) along the riser pipe (10), the frame (40) being in a hoisting orientation.

39. Riser system according to claim 36, wherein the frame (40) comprises a winch (44) with a rope (4), the winch (44) being position near the first connection member (41) and the riser pipe (10) comprises a rope connection member (14) along the riser pipe near the second connection member (15), wherein the rope (4) can be connected to the rope connection member (14) and the position of the frame (40) can be adjusted relative to the riser pipe (10) by pulling in the rope (4) by the winch (44).

40. The riser system according to claim 36, wherein the frame (40) further comprises a winch (44) with a rope (4) positioned near a first connection member (41), the riser system further comprises a rope connection member (14) provided along the pipe (10) above the pipe input opening (12),
wherein the winch (44) is arranged to give out rope (4) when the frame (40) approaches the location along the riser pipe (10) to which the frame (40) is to be mounted,
wherein the rope (4) is connectable to the rope connection member (14), and
wherein the winch (44) comprises an actuator arranged to pull in the rope (4) to bring the first connection member (41) towards the second connection member (15).

41. The riser system according to claim 37, wherein at least one of the pump output opening (32), the pipe input opening (12), the pump input opening (31), and the intermediate pipe output opening (13) comprise a widening end part to catch the other of the pump output opening (32), the pipe input opening (12), the pump input opening (31), or the intermediate pipe output opening (13) when the frame reaches the hanging position.

42. The riser system according to claim 37, wherein the riser system comprises a plurality of intermediate pipe input openings (12) positioned at different intermediate positions along the pipe (10) and intermediate pipe output openings (13) adjacent the respective intermediate pipe input openings (12), and wherein the riser system comprises a number of second connection members (15) at the predetermined distance above the respective intermediate pipe input openings (12).

43. The riser system according to claim 36, wherein the frame (40) comprises a first power connection member and/or a first control connection member, wherein a second power connection member and/or a second control connection member is provided along the riser pipe, the first and second power connection members and/or control connection members having the same relative position with respect to the first and second connection member (41, 15), such that in the hanging position the first and second power connection members and/or control connection members connect to each other.

44. The riser system according to claim 36, comprising a locking device (33) arranged to lock the pump output opening (32) to the pipe input opening (12) and/or to lock the pump input opening (32) to the pipe output opening (12).

45. The riser system according to claim 37, wherein at least one of the pump input opening (31), the intermediate pipe output opening (13), the pump output opening (32) and the intermediate pipe input opening (12) comprises a sealing member for sealing the connection between the pump input opening (31) and the pipe output opening (13) and/or the connection between the pump output opening (32) and the pipe input opening (12).

46. The riser system according to claim 36, wherein the first connection member (41) is a hook, and the second connection member (15) is a hook receiving member.

47. A method for connecting a frame (40), comprising a pump (30), to a riser pipe (10),
the frame (40) comprising a first connection member (41), a hoisting connection member (43), a winch (44) with a rope (4), the winch (44) being positioned near the first connection member (41)
the riser pipe (10) comprising a second connection member (15) and a rope connection member (14) along the riser pipe near the second connection member (15)
the method comprising:
hoisting the frame (40) to a suitable height, whereby the frame (40) is in a hoisting orientation;
connecting the rope (4) to the rope connection member (14);
adjusting the position of the frame (40) relative to the riser pipe (10) by pulling in the rope (4) by the winch (44);
connecting the first connection member (41) of the frame (40) to the second connection member (15) of the riser pipe (10);
making the frame (40) rotate into a hanging position under influence of gravity;
connecting an output opening (32) of the pump (30) to an input opening (12) of the riser pipe (10).

48. The method according to claim 47, comprising the step of:
connecting an input opening (31) of the pump (30) to an output opening (13) of the riser pipe (10).

49. The method according to claim 48, wherein the pipe input opening (12) is an intermediate pipe input opening (12) positioned at an intermediate position along the pipe (10) and the pipe output opening is an intermediate pipe output opening (13) adjacent the intermediate pipe input opening (12).

50. A frame for a riser system, wherein the frame (40) carries a pump (30) with a pump input opening (31) and a pump output opening (32), wherein the frame (40) comprises a connection member (41) at a predetermined distance from the pump output opening (32), which connection member (41) is arranged to be rotatably mounted to a riser pipe (10), allowing the frame (40) to perform a rotation after connection under the influence of gravity to a hanging position, wherein an axis of the pump output opening (32) is substantially tangentially directed with respect to the rotation of the frame (40),
wherein the frame (40) further comprises a winch (44) with a rope (4) positioned close to the first connection member (41),
wherein the winch (44) is arranged to give out rope (4) during when the frame (44) approaches the location along the riser pipe (10) to which the frame (40) is to be mounted,
wherein the rope (4) is connectable to a rope connection member (14) along the pipe (10) above the pipe input opening (12) provided on the riser system, and
wherein the winch (44) comprises an actuator which is arranged to pull in the rope (4) to connect the connection member (41) to the riser pipe (10).

51. The frame according to claim 50, wherein the frame (40) comprises a hoist connection member (43) to which a hoisting cable (51) can be attached to lower and lift the frame (40) along a riser pipe (10), the frame (40) being in a hoisting orientation.

52. The frame according to claim 50, wherein at least one of the pump output opening (32) and the pump input opening (31) is provided with a sealing member and/or a locking device.

53. The frame according to claim 50, wherein the frame comprises a power connection member and/or a control connection member that is substantially tangentially directed with respect to the rotation direction of the frame (40).

54. A riser pipe for a riser system, wherein the riser pipe (10) comprises a pipe input opening (12) and a connection member (15) at a predetermined distance above the pipe input opening (12), which connection member (15) is arranged to be connected to a frame (40), wherein the pipe input opening is an intermediate pipe input positioned at an intermediate position along the pipe (10) and the riser pipe (10) further comprises an intermediate pipe output opening (13) adjacent the intermediate pipe input opening (12), and wherein the intermediate pipe output opening (13) comprises a widening end part.

55. The riser pipe according to claim 54, wherein the connection member (15) is arranged to be rotatably mounted to a frame, allowing the frame (40) to perform a rotation after connection under the influence of gravity to a hanging position, wherein an axis of the pipe input opening (12) is substantially tangentially directed with respect to the rotation of the frame (40).
